(19) United States
(12) Patent Application Publication
(10) Pub. No.: US 2016/0360185 A1
(43) Pub. Date: Dec. 8, 2016

(54) THREE-DIMENSIONAL IMAGING SENSOR CALIBRATION

(71) Applicant: Empire Technology Development LLC, Wilmington, DE (US)

(72) Inventors: Mordehai Margalit, Zichron Yaaqov (IL); Youval Nehmadi, Nili (IL)

(21) Appl. No.: 14/730,078

(22) Filed: Jun. 3, 2015

(51) Int. Cl. H04N 13/02; G06T 7/00

(52) U.S. Cl. CPC H04N 13/0246; H04N 13/0296; H04N 13/0253; H04N 13/0257; G06T 7/002; H04N 2013/0081

(57) ABSTRACT

Technologies are generally described for calibrating three-dimensional image sensors. In some examples, an imaging system may include a sensor for detecting two-dimensional image data associated with a scene and a sensor for detecting depth data associated with the scene. Both sensors may also be configured to detect a reference signal used to illuminate the scene. The imaging system may then be configured to form three-dimensional data about the scene by using the reference signal to combine the two-dimensional image data and the depth data.

### BACKGROUND

Unless otherwise indicated herein, the materials described in this section are not prior art to the claims in this application and are not admitted to be prior art by inclusion in this section.

Three-dimensional imaging is used in applications such as computer vision, autonomous navigation, mapping, and gesture recognition, among others. Many three-dimensional imaging systems use multiple image sensors to acquire information about a three-dimensional scene or environment. For example, an imaging system may use a sensor configured to acquire two-dimensional image data about a scene and a sensor configured to acquire depth information about the scene. The two-dimensional image data and the depth information may then have to be calibrated or linked in order to provide correct three-dimensional information about the scene.

### SUMMARY

The present disclosure generally describes techniques to calibrate three-dimensional imaging systems.

According to some examples, a method is provided to calibrate an image sensor. The method may include detecting, at the image sensor, two-dimensional image data including multiple image pixels of a scene and a reference signal associated with at least one image pixel of the multiple image pixels and transmitted from a vicinity of the image sensor to the scene. The method may further include determining, based on the detected reference signal, a depth associated with the at least one image pixel.

According to other examples, an image sensor system is provided to calibrate image data. The system may include an image sensor configured to detect two-dimensional image data associated with a scene and including multiple image pixels. The sensor may further include a reference signal filter configured to cause the image sensor to detect a returned reference signal associated with at least one image pixel of the multiple image pixels, where the returned reference signal is transmitted from a vicinity of the image sensor onto the scene. The system may further include a processor block configured to determine, based on the detected reference signal, a depth associated with the at least one image pixel.

According to further examples, an imaging system is provided to calibrate image data. The system may include a transmitter configured to transmit a reference signal and an image sensor. The image sensor may be configured to detect the reference signal and two-dimensional image data associated with a scene. The reference signal may be associated with at least one image pixel of multiple pixels of the two-dimensional image data. The system may also include a processor block configured to determine depth data based on the detected reference signal and form three-dimensional scene data based on the two-dimensional image data and the depth data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example three-dimensional imaging system;

FIG. 2 illustrates an example three-dimensional imaging system that implements calibration with a reference signal;

FIG. 3 illustrates how calibration of a three-dimensional imaging system may be implemented using different frames;

FIG. 4 illustrates a general purpose computing device, which may be used to calibrate three-dimensional imaging sensors;

FIG. 5 is a flow diagram illustrating an example method to calibrate three-dimensional imaging sensors that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to calibration of three-dimensional imaging systems.

Briefly stated, technologies are generally described for calibrating three-dimensional image sensors. In some examples, an imaging system may include a sensor for detecting two-dimensional image data associated with a scene and a sensor for detecting depth data associated with the scene. Both sensors may also be configured to detect a reference signal used to illuminate the scene. The imaging system may then be configured to form three-dimensional data about the scene by using the reference signal to combine the two-dimensional image data and the depth data.

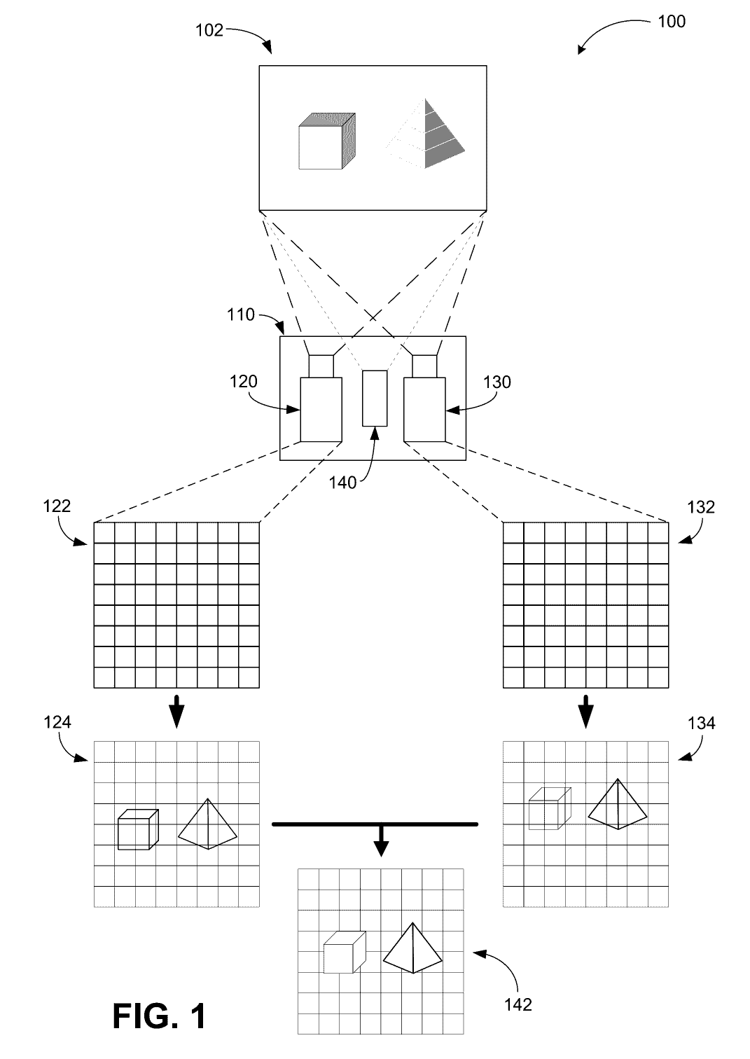

FIG. 1 illustrates an example three-dimensional imaging system, arranged in accordance with at least some embodiments described herein.

According to a diagram 100, an imaging system 110 may be configured to detect image data associated with a scene 102. The scene 102 may be a two-dimensional scene (for example, a picture) or a three-dimensional scene (for example, a room or an environment surrounding the imaging system 110). The imaging system 110 may include a first image sensor 120 configured to detect two-dimensional image data associated with the scene 102. In some embodiments, the first image sensor 120 may detect the two-dimensional image data as visible light reflected or emitted from the scene 102 and/or elements within the scene 102. The first image sensor 120 may be configured to detect the visible light using a pixel array 122, which may be implemented using charge-coupled device (CCD) technology, complementary metal oxide semiconductor (CMOS) technology, and/or any other suitable image capture technology. The pixel array 122, upon detecting visible light from the scene 102, may generate two-dimensional image data 124 based on the scene 102. In some embodiments, a particular pixel in the pixel array 122 may correspond to a particular pixel in the two-dimensional image data 124. In other embodiments, interpolation and/or averaging may be used to increase and/or reduce the number of pixels in the image data 124 as compared to the pixel array 122. In some embodiments, each pixel in the pixel array 122 may be associated with one or more color filters. For example, a pixel may be associated with a red color filter, a green color filter, and a blue color filter. The color filters may be selected to allow a pixel to capture any color light in substantially the entire visible color spectrum, although in other embodiments the color filters may only allow light within a portion of the visible color spectrum to be captured.

The imaging system 110 may also include a second image sensor 130 and a reference signal transmitter 140 configured to detect depth information indicative of the structure or shape of particular features, objects, and/or surfaces in the scene 102. The reference signal transmitter 140 is configured to transmit a reference signal at the scene 102, either periodically or continuously. The reference signal may then be reflected by features, objects, and/or surfaces in the scene 102 and return to the imaging system 110. The second image sensor 130 may then detect the returned reference signal. In some embodiments, the reference signal may be infrared or some other invisible or undetectable light for the first image sensor 120 and/or any users in the scene 102 in order to avoid interfering with the first image sensor 120 and/or users. Of course, in other embodiments, the reference signal may be visible or near-visible, and the first image sensor 120 may be configured to detect near-visible, infrared, ultraviolet, and/or light of any other suitable wavelength. The reference signal transmitter 140 may be in the vicinity of (that is, be physically close to) the second image sensor 130, or may be disposed some distance away.

The reference signal, which may be a laser signal and/or a structured light signal, may provide depth information when reflected by features, objects, and/or surfaces in the scene 102 and subsequently detected by the second image sensor 130. For example, the time-of-flight of the reference signal (the time between transmission of the signal and reception of the reflected signal) may provide information regarding the distance between a particular feature, object, or surface in the scene 102 and the transmitter 140 and/or the second image sensor 130. A structured light signal, which may be generated using a laser, may have an initial structure or pattern (for example, a grid of straight lines). When the structured light signal is transmitted at the scene 102, features, objects, and surfaces in the scene 102 may modify how the initial pattern of the structured light signal is reflected. The resulting pattern of the reflected signal detected by the second image sensor 130 may then provide information about the shape or topology of the scene 102 and/or features within the scene 102.

The second image sensor 130 may be configured to detect the reflected reference signal using a pixel array 132, similar to the pixel array 122 but configured to detect signals with wavelength/frequency similar to the reference signal. For example, pixels in the pixel array 132 may have a filter selected to correspond to the wavelength/frequency of the reference signal, but may not have filters corresponding to colors in the visible spectrum. The pixel array 132 may be implemented using CCD technology, CMOS technology, or any other suitable image capture technology. Upon detecting a reflected reference signal from the scene 102 at one or more pixels of the pixel array 132, the second image sensor 130 may determine depth information from the reflected reference signal (for example, using time-of-flight or structured-light information), and may associate the determined depth information to the pixel(s) of the pixel array 132 at which the reflected reference signal was detected. In this way, the second image sensor 130 may construct depth data 134. As with the two-dimensional image data 124, a particular pixel in the pixel array 132 may correspond to a particular pixel in the depth data 134, or interpolation and/or averaging may be used to increase and/or reduce the number of pixels in the depth data 134 as compared to the pixel array 132. The imaging system 110 may then map the depth data 134 to the two-dimensional image data 124 to form a three-dimensional image 142.

In some embodiments, the reference signal transmitter 140 may be configured to scan the reference signal over the scene 102. For example, a laser or structured light reference signal may have a relatively small spot size compared to the scene 102. Accordingly, the reference signal transmitter 140 may scan the reference signal across the scene 102. In some embodiments, the transmitter 140 may perform the scanning by steering the reference signal in different directions, physically (for example, rotating at least a portion of the reference signal source about one or more axes) and/or electronically (for example, using interference to generate reference signals oriented in different directions). In some embodiments, the transmitter may record one or more parameters associated with the scanning (for example, rotational coordinates and/or parameters involved in electronically generating the reference signal). The parameters may then be combined with reflection data detected by the pixel array 132 to determine the depth data 134.

In some embodiments, the first image sensor 120 and the second image sensor 130, being separate (distinct) sensors, may have slightly different fields-of-view. As a result, the portion(s) of the scene 102 captured by the two-dimensional image data 124 may not exactly match the portion(s) of the scene 102 captured by the depth data 134. In some embodiments, the imaging system 110 may calibrate the first image sensor 120 and the second image sensor 130 so that the imaging system 110 can determine associated portions of the two-dimensional image data 124 and the depth data 134. This calibration procedure may involve attempting to match portions of the two-dimensional image data 124 to portions of the depth data 134, and may require significant and lengthy processing by the imaging system 110.

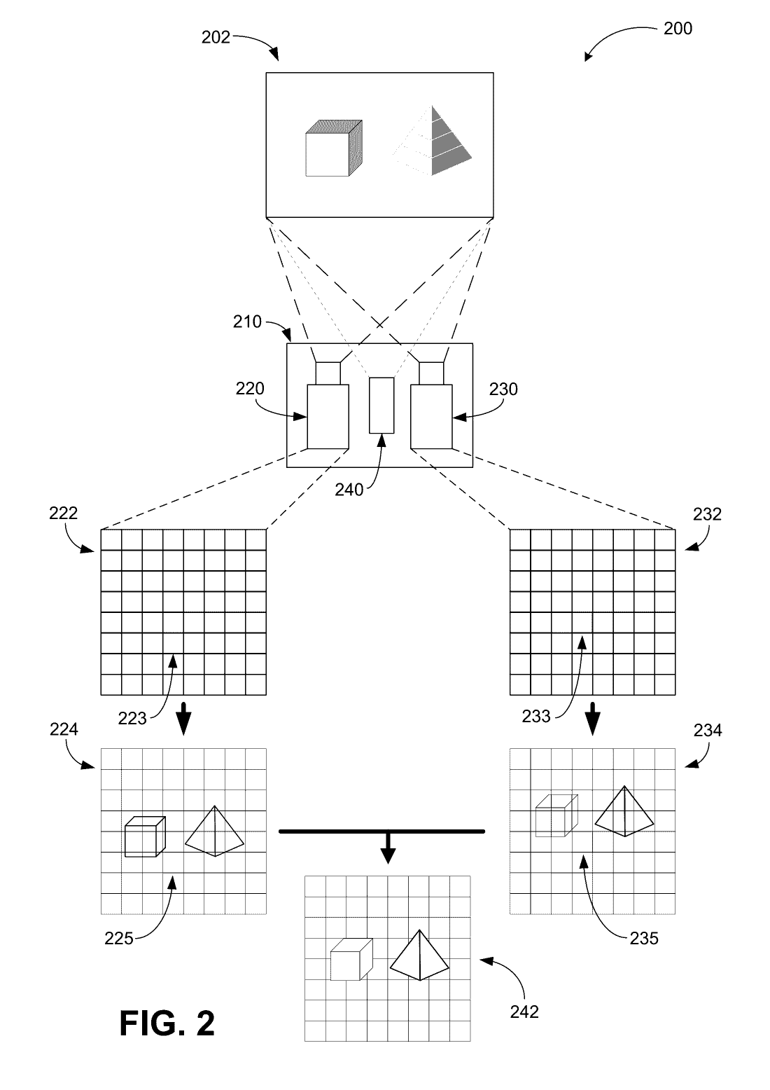

FIG. 2 illustrates an example three-dimensional imaging system that implements calibration with a reference signal, arranged in accordance with at least some embodiments described herein.

According to a diagram 200, an imaging system 210 (similar to the imaging system 110) may be configured to detect image data associated with a scene 202, similar to the scene 102. The imaging system 210 may include a first image sensor 220 similar to the first image sensor 120, a second image sensor 230 similar to the second image sensor 130, and a reference signal transmitter 240 similar to the reference signal transmitter 140. In some embodiments, the first image sensor 220 may be configured to detect light from the scene 202 using a pixel array 222, similar to the pixel array 122, and may generate two-dimensional image data 224 based on the scene 202, similar to two-dimensional image data 124. The reference signal transmitter 140 may be configured to transmit a reference signal at the scene 202 for reflection, and the second image sensor 230 may be configured to detect the reflected reference signal using a pixel array 232 similar to the pixel array 132 to construct depth data 234, similar to depth data 134.

Differently from the imaging system 110 and the first image sensor 120, the first image sensor 220 may be configured to detect the reference signal transmitted by the reference signal transmitter 240. One or more pixels in the pixel array 222 may be associated with filters selected to correspond to the wavelength of the reference signal. In some embodiments, each pixel in the pixel array 222 may be associated with, in addition to color filters for detecting visible light, an infrared filter for detecting an infrared reference signal. In some embodiments, certain pixels in the pixel array 222 may be dedicated to detecting the reference signal. Such dedicated pixels may be similar to pixels in the pixel array 232 in that they may only have infrared filters but may not have filters corresponding to colors in the visible spectrum. In this case, the pixel array 222 may include fewer reference-signal-dedicated pixels than pixels for detecting visible light. For example, the pixel array 222 may have one reference-signal-dedicated pixel per ten other pixels. The reference-signal-dedicated pixels may be distributed across the pixel array 222, uniformly or non-uniformly.

When a reference signal transmitted by the transmitter 240 reflects from features, objects, and/or surfaces in the scene 202, both the first image sensor 220 and the second image sensor 230 may detect the reflected reference signal. For example, a pixel 223 at the pixel array 222 of the first image sensor 220 may detect a reflected reference signal at a particular time, and a pixel 233 at the pixel array 232 of the second image sensor 230 may also detect a reflected reference signal at that particular time. Based on the reflected reference signal detection, the imaging system 210 may be able to determine that the pixel 223 at the pixel array 222 and the pixel 233 at the pixel array 232 are directed to the same portion of the scene 202 and may therefore be associated. Subsequently, the imaging system 210 may then be able to determine that a pixel 225 in the two-dimensional image data 224 (which may correspond to the pixel 223) and a pixel 235 in the depth data 234 (which may correspond to the pixel 233) can be mapped together in a three-dimensional image 242. As a result, the imaging system 210 may be able to calibrate the first image sensor 220 and the second image sensor 230 simply by associating pixels at which a reflected reference signal are detected at a particular time.

In some embodiments, an imaging system such as the imaging system 210 may be configured to detect and store a sequence of two-dimensional image data frames. In these embodiments, the imaging system may be configured to use certain frames of the sequence to construct the final two-dimensional image data, such as the two-dimensional image data 224. The imaging system may further use certain other frames of the sequence to determine the location of the reflected reference signal for calibration purposes. For example, the imaging system may be configured to first detect two-dimensional image data using a sequence of three frames, and then detect the reflected reference signal using the fourth frame. The frequency of reference signal detection, which was one in four in the previous example, may be determined by the imaging system based on the frame rate (that is, the time rate at which the sequence of frames is being captured) and/or scene dynamics, such as how quickly objects and features in the scene (or the imaging system) are moving. The rate at which the reference signal is transmitted may also be based on the frame rate and/or scene dynamics. In some embodiments, an imaging system may be configured to detect both two-dimensional image data and depth data using the same image sensor operating in the manner described above.

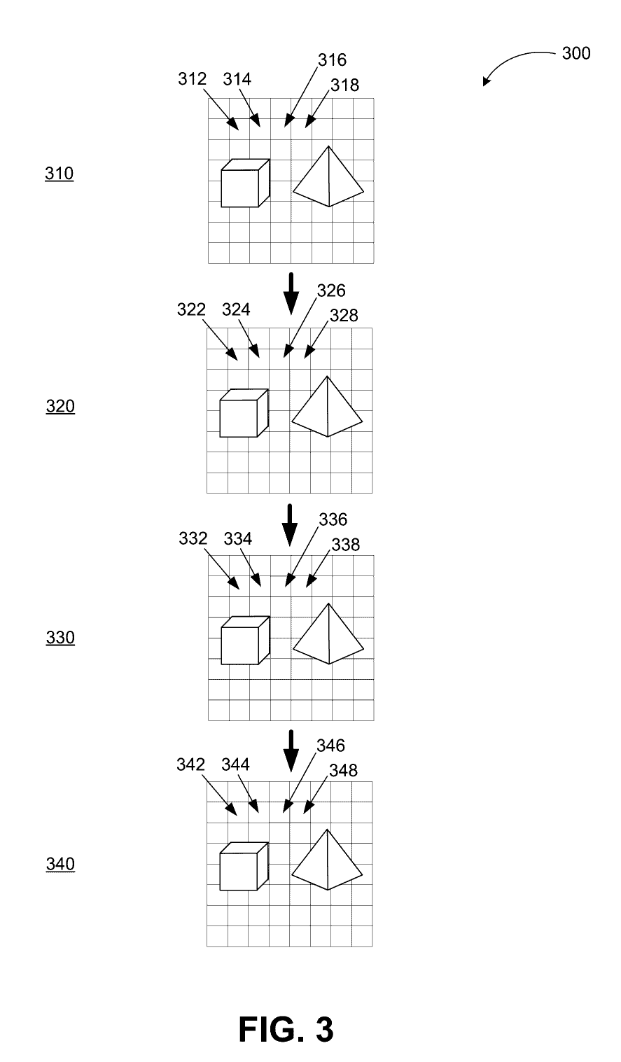

FIG. 3 illustrates how calibration of a three-dimensional imaging system may be implemented using different frames, arranged in accordance with at least some embodiments described herein.

According to a diagram 300, a three-dimensional imaging system may detect and store a sequence of two-dimensional image data frames 310, 320, 330, and 340. As described above, in some embodiments the imaging system may use certain frames to construct the final two-dimensional image data and other frames to determine the location of a reflected reference signal. In some embodiments, the imaging system may select frames at times when the reference signal is not transmitted or received to construct the final two-dimensional image data. However, in situations where the reference signal is transmitted continuously or with a low period (that is, high time frequency), there may not be frames available that do not include a reflected reference signal. In these situations, the imaging system may be configured to derive image data for a particular, reference-signal-obscured pixel from corresponding pixels in neighboring frames. For example, the frame 310 may include four image pixels 312, 314, 316, and 318. In the frame 310, the image pixel 312 may detect a reflected reference signal and may not detect image information. In the subsequent frame 320, which may include four image pixels 332, 334, 336, and 338, the image pixel 334 may detect a reflected reference signal and may not detect image information. In the frame 330, which may include four image pixels 332, 334, 336, and 338, the image pixel 336 may detect a reflected reference signal and may not detect image information. In the frame 340, which may include four image pixels 342, 344, 346, and 348, the image pixel 346 may detect a reflected reference signal and may not detect image information. In some embodiments, corresponding pixels from neighboring frames may be used to supply image data. For example, image data for the image pixel 312 may be provided from the corresponding pixels 322, 332, and 342 in the frames 320, 330, and 340, respectively. Image data for the image pixel 324 may be supplied from the corresponding pixels 314, 334, and/or 344. Image data for the image pixel 336 may be supplied from the corresponding pixels 316, 326, and/or 346, and image data for the image pixel 348 may be provided from the pixels 318, 328, and/or 338.

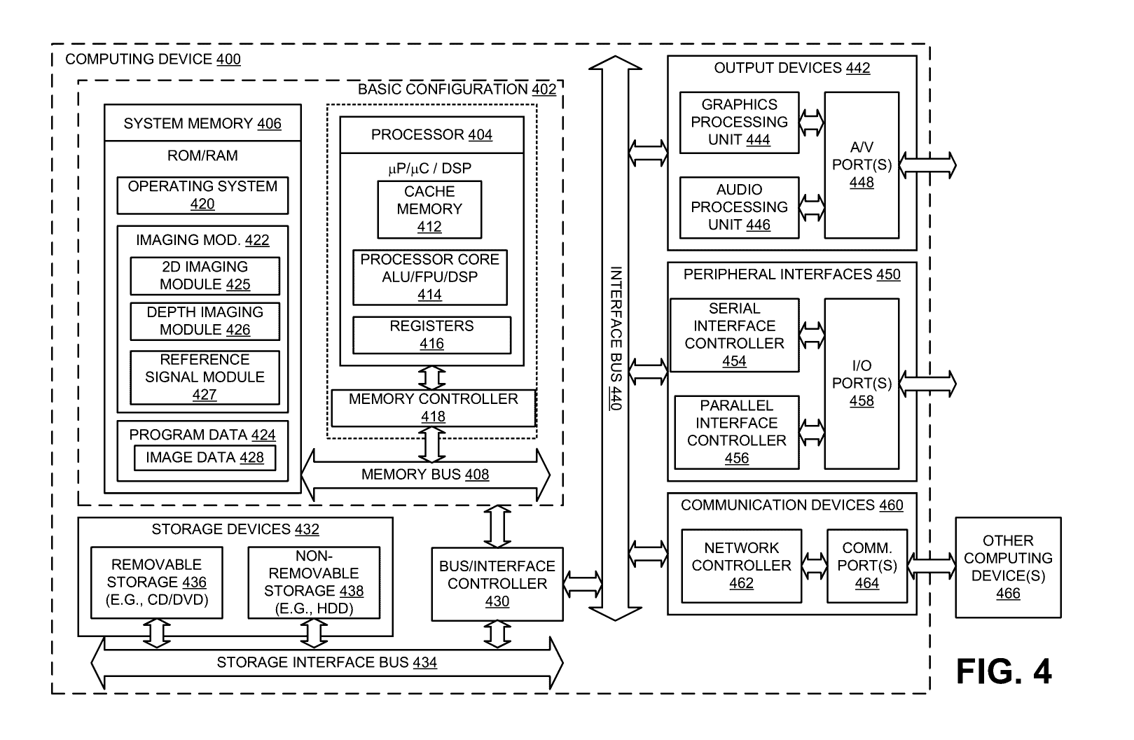

FIG. 4 illustrates a general purpose computing device, which may be used to calibrate three-dimensional imaging systems, arranged in accordance with at least some embodiments described herein.

For example, the computing device 400 may be used to calibrate three-dimensional imaging sensors as described herein. In an example basic configuration 402, the computing device 400 may include one or more processors 404 and a system memory 406. A memory bus 408 may be used to communicate between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a level cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, an imaging module 422, and program data 424. The imaging module 422 may include a 2D imaging module 425, a depth imaging module 426, and a reference signal module 427 to implement three-dimensional imaging calibration as described herein. The program data 424 may include, among other data, image data 428 or the like, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., one or more output devices 442, one or more peripheral interfaces 444, and one or more communication devices 466) to the basic configuration 402 via the bus/interface controller 430. Some of the example output devices 442 include a graphics processing unit 448 and an audio processing unit 450, which may be configured to communicate to various external devices such as a display or speakers via one or more A/V ports 452. One or more example peripheral interfaces 444 may include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 466 includes a network controller 460, which may be arranged to facilitate communications with one or more other computing devices 462 over a network communication link via one or more communication ports 464. The one or more other computing devices 462 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a part of a general purpose or specialized server, mainframe, or similar computer that includes any of the above functions. The computing device 400 may also be implemented as a personal computer including both laptop computer and non-laptop computer configurations.

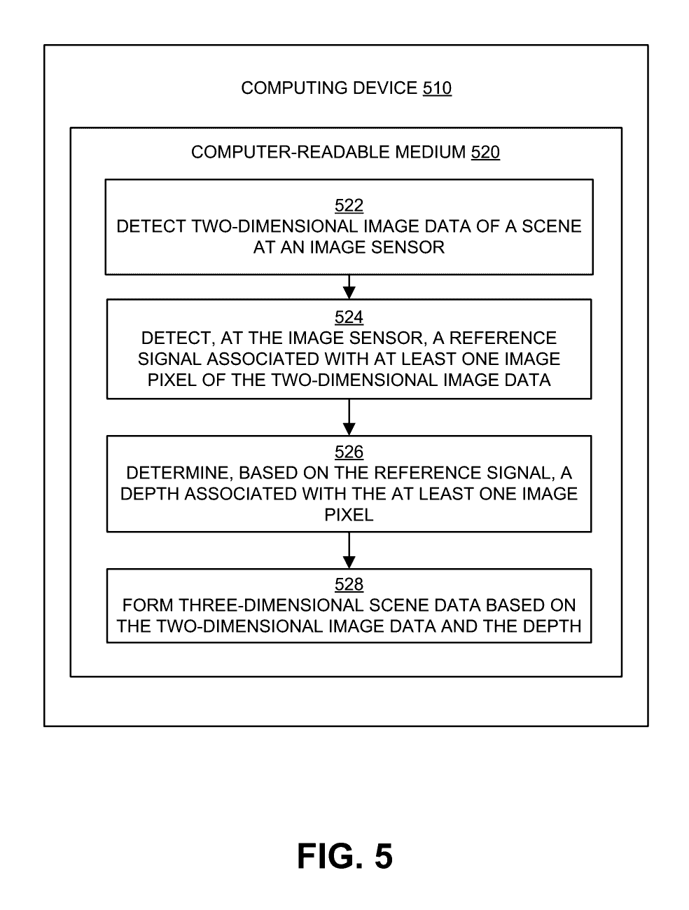

FIG. 5 is a flow diagram illustrating an example method to calibrate three-dimensional imaging systems that may be performed by a computing device such as the computing device in FIG. 4, arranged in accordance with at least some embodiments described herein.

Example methods may include one or more operations, functions or actions as illustrated by one or more of blocks 522, 524, 526, and/or 528, and may in some embodiments be performed by a computing device such as the computing device 500 in FIG. 5. The operations described in the blocks 522-528 may also be stored as computer-executable instructions in a computer-readable medium such as a computer-readable medium 520 of a computing device 510.

An example process to calibrate a three-dimensional imaging system may begin with block 522, “DETECT TWO-DIMENSIONAL IMAGE DATA OF A SCENE AT AN IMAGE SENSOR”, where an imaging system such as the imaging system 210 may use an image sensor such as the first image sensor 220 to detect visible light reflecting from a scene. The image sensor may generate two-dimensional image data using a pixel array such as the pixel array 222, as described above.

Block 522 may be followed by block 524, “DETECT, AT THE IMAGE SENSOR, A REFERENCE SIGNAL ASSOCIATED WITH AT LEAST ONE IMAGE PIXEL OF THE TWO-DIMENSIONAL IMAGE DATA”, where the imaging system may use the same image sensor to also detect a reference signal reflected from the scene at one or more pixels of the image sensor at a particular time. In some embodiments, the imaging system itself may include a reference signal transmitter, such as the reference signal transmitter 240, configured to transmit the reference signal at the scene. The reference signal may have a wavelength significantly different from the reflected light converted into the two-dimensional image data, and the image sensor may detect the reference signal using pixels with filters selected for the reference signal, as described above.

Block 524 may be followed by block 526, “DETERMINE, BASED ON THE REFERENCE SIGNAL, A DEPTH ASSOCIATED WITH THE AT LEAST ONE IMAGE PIXEL”, where the imaging system may use another sensor such as the second image sensor 230 to use the reference signal to determine depth information associated with the pixels of the image sensor at which the reference signal was detected at the particular time. In some embodiments, the imaging system uses the other sensor in conjunction with the reference signal transmitter to measure some parameter of the reference signal for depth determination. For example, the imaging system may determine a time-of-flight parameter of the reference signal, or may determine how a structured light reference signal is modified by reflection from the scene.

Block 526 may be followed by block 528, “FORM THREE-DIMENSIONAL SCENE DATA BASED ON THE TWO-DIMENSIONAL IMAGE DATA AND THE DEPTH”, where the imaging system may assemble the detected two-dimensional image data and the determined depth information by mapping the two-dimensional image data to the depth information based on the particular time and pixel location at which the reflected reference signal was detected, as described above.

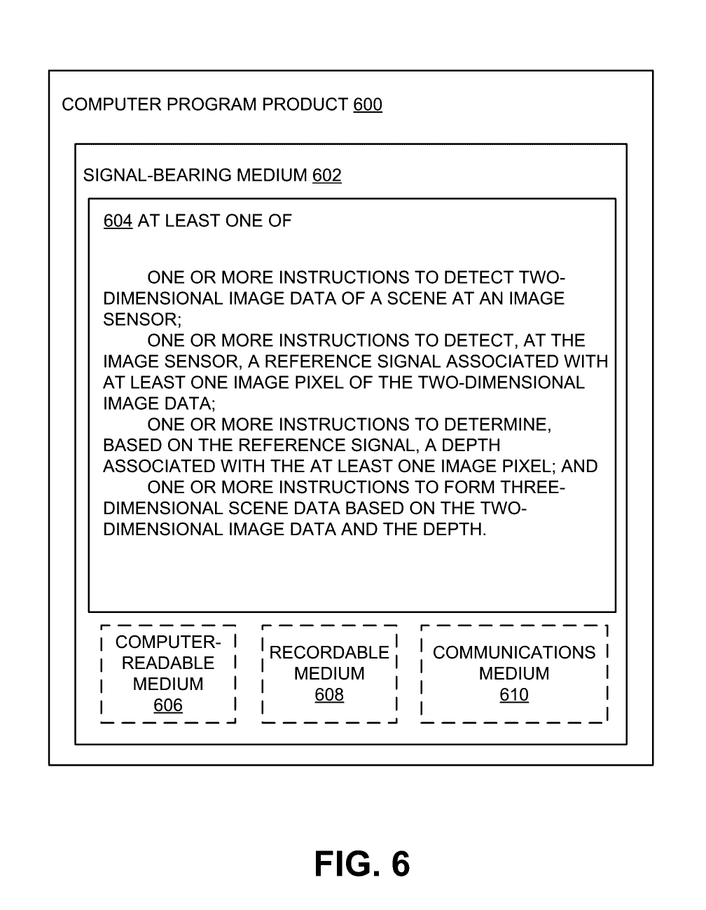

FIG. 6 illustrates a block diagram of an example computer program product, arranged in accordance with at least some embodiments described herein.

In some examples, as shown in FIG. 6, a computer program product 600 may include a signal bearing medium 602 that may also include one or more machine readable instructions 604 that, when executed by, for example, a processor may provide the functionality described herein. Thus, for example, referring to the processor 404 in FIG. 4, the imaging module 422 may undertake one or more of the tasks shown in FIG. 6 in response to the instructions 604 conveyed to the processor 404 by the medium 602 to perform actions associated with calibrating three-dimensional image sensors as described herein. Some of those instructions may include, for example, instructions to detect two-dimensional image data of a scene at an image sensor, detect, at the image sensor, a reference signal associated with at least one image pixel of the two-dimensional image data, determine, based on the reference signal, a depth associated with the at least one image pixel, and/or form three-dimensional scene data based on the two-dimensional image data and the depth, according to some embodiments described herein.

In some implementations, the signal bearing media 602 depicted in FIG. 6 may encompass computer-readable media 606, such as, but not limited to, a hard disk drive, a solid state drive, a compact disc (CD), a digital versatile disk (DVD), a digital tape, memory, etc. In some implementations, the signal bearing media 602 may encompass recordable media 607, such as, but not limited to, memory, read/write (R/W) CDs, R/W DVDs, etc. In some implementations, the signal bearing media 602 may encompass communications media 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing media 602 is conveyed by the wireless communications media 610 (e.g., a wireless communications medium conforming with the IEEE 802.11 standard).

According to some examples, a method is provided to calibrate an image sensor. The method may include detecting, at the image sensor, two-dimensional image data including multiple image pixels of a scene and a reference signal associated with at least one image pixel of the multiple image pixels and transmitted from a vicinity of the image sensor to the scene. The method may further include determining, based on the detected reference signal, a depth associated with the at least one image pixel.

According to some embodiments, detecting the reference signal may include detecting an infrared laser signal and/or detecting a structured light signal. Determining the depth may include determining the depth based on a time-of-flight parameter associated with the detected reference signal. In some embodiments, determining the depth may include mapping the at least one image pixel to at least one depth data element, and the at least one depth data element may be associated with the detected reference signal.

According to other embodiments, detecting the reference signal may include detecting the reference signal using a first sensor pixel having an infrared filter and at least one color filter and/or a second sensor pixel having an infrared filter and no color filters. Detecting the two-dimensional image data may include detecting the two-dimensional image data in at least one image frame of a sequence of image frames. Detecting the reference signal may include detecting the reference signal in at least one other image frame of the sequence of image frames. The method may further include adjusting a frequency of detection of the reference signal in the at least one other image frame based on one or both of a frame rate associated with the sequence of image frames and scene dynamics. In some embodiments, detecting the two-dimensional image data may include determining that the detected reference signal is present in all image frames in a sequence of image frames and retrieving data for an image pixel obscured by the detected reference signal in a first image frame from a corresponding image pixel in a second image frame.

According to other examples, an image sensor system is provided to calibrate image data. The system may include an image sensor configured to detect two-dimensional image data associated with a scene and including multiple image pixels. The sensor may further include a reference signal filter configured to cause the image sensor to detect a returned reference signal associated with at least one image pixel of the multiple image pixels, where the returned reference signal is transmitted from a vicinity of the image sensor onto the scene. The system may further include a processor block configured to determine, based on the detected reference signal, a depth associated with the at least one image pixel.

According to some embodiments, the reference signal may include an infrared laser signal and/or a structured light signal. The processor may be further configured to determine the depth based on a time-of-flight parameter associated with the reference signal. The processor may be configured to determine the depth by mapping the at least one image pixel to at least one depth data element associated with the detected reference signal. The reference signal filter may include an infrared filter for a first sensor pixel having at least one color filter and/or an infrared filter for a second sensor pixel having no color filters.

According to other embodiments, the image sensor may be further configured to detect the two-dimensional image data in at least one image frame of a sequence of image frames and detect the reference signal in at least one other image frame of the sequence of image frames. The processor may be further configured to adjust a frequency of detection of the reference signal in the at least one other image frame based on one or both of a frame rate associated with the sequence of image frames and scene dynamics. In some embodiments, the processor block may be further configured to determine that the reference signal is present in all image frames in a sequence of image frames and retrieve data for an image pixel in a first image frame obscured by the reference signal from a corresponding image pixel in a second image frame.

According to further examples, an imaging system is provided to calibrate image data. The system may include a transmitter configured to transmit a reference signal and an image sensor. The image sensor may be configured to detect the reference signal and two-dimensional image data associated with a scene. The reference signal may be associated with at least one image pixel of multiple pixels of the two-dimensional image data. The system may also include a processor block configured to determine depth data based on the detected reference signal and form three-dimensional scene data based on the two-dimensional image data and the depth data.

According to some embodiments, the transmitter may be configured to transmit the reference signal as one of an infrared laser signal and a structured light signal. The processor block may be configured to determine the depth data based on a time-of-flight parameter associated with the reference signal. In some embodiments, the processor block may be configured to form the three-dimensional scene data by mapping at least one image pixel in the two-dimensional image data and at least one depth data element in the depth data using the reference signal. The image sensor includes an infrared filter for a first sensor pixel having at least one color filter and/or an infrared filter for a second sensor pixel having no color filters.

According to other embodiments, the image sensor may be further configured to detect the two-dimensional image data in at least one image frame of a sequence of image frames and detect the reference signal in at least one other image frame of the sequence of image frames. The processor block may be further configured to adjust a frequency of detection of the reference signal in the at least one other image frame based on one or both of a frame rate associated with the sequence of image frames and scene dynamics. In some embodiments, the processor block may be further configured to determine that the reference signal is present in all image frames in a sequence of image frames and retrieve data for an image pixel in a first image frame obscured by the reference signal from a corresponding image pixel in a second image frame.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or^{,} “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to calibrate an image sensor, the method comprising:
detecting, at the image sensor, two-dimensional image data including a plurality of image pixels of a scene;
detecting, at the image sensor, a reference signal associated with at least one image pixel of the plurality of image pixels, the reference signal transmitted from a vicinity of the image sensor to the scene; and
determining, based on the detected reference signal, a depth associated with the at least one image pixel.

2. The method of claim 1, wherein detecting the reference signal comprises at least one of:
detecting an infrared laser signal; and
detecting a structured light signal.

3. The method of claim 1, wherein determining the depth comprises determining the depth based on a time-of-flight parameter associated with the detected reference signal.

4. The method of claim 1, wherein:
determining the depth comprises mapping the at least one image pixel to at least one depth data element; and
the at least one depth data element is associated with the detected reference signal.

5. The method of claim 1, wherein detecting the reference signal comprises detecting the reference signal using at least one of:
a first sensor pixel having an infrared filter and at least one color filter; and
a second sensor pixel having an infrared filter and no color filters.

6. The method of claim 1, wherein:
detecting the two-dimensional image data comprises detecting the two-dimensional image data in at least one image frame of a sequence of image frames; and
detecting the reference signal comprises detecting the reference signal in at least one other image frame of the sequence of image frames.

7. The method of claim 6, further comprising adjusting a frequency of detection of the reference signal in the at least one other image frame based on one or both of a frame rate associated with the sequence of image frames and scene dynamics.

8. The method of claim 1, wherein detecting the two-dimensional image data comprises:
determining that the detected reference signal is present in all image frames in a sequence of image frames; and
retrieving data for an image pixel obscured by the detected reference signal in a first image frame from a corresponding image pixel in a second image frame.

9. An image sensor system comprising:
an image sensor configured to detect two-dimensional image data associated with a scene, wherein the two-dimensional image data includes a plurality of image pixels;
a reference signal filter configured to cause the image sensor to detect a returned reference signal associated with at least one image pixel of the plurality of image pixels, wherein the returned reference signal is transmitted from a vicinity of the image sensor onto the scene; and
a processor configured to determine, based on the detected reference signal, a depth associated with the at least one image pixel.

10. The system of claim 9, wherein the reference signal comprises at least one of:
an infrared laser signal; and
a structured light signal.

11. The system of claim 9, wherein the processor is further configured to determine the depth based on a time-of-flight parameter associated with the reference signal.

12. The system of claim 9, wherein the processor is configured to determine the depth by mapping the at least one image pixel to at least one depth data element associated with the detected reference signal.

13. The system of claim 9, wherein the reference signal filter includes at least one of:
an infrared filter for a first sensor pixel having at least one color filter; and
an infrared filter for a second sensor pixel having no color filters.

14. The system of claim 9, wherein the image sensor is further configured to:
detect the two-dimensional image data in at least one image frame of a sequence of image frames; and
detect the reference signal in at least one other image frame of the sequence of image frames.

15. The system of claim 14, wherein the processor is further configured to adjust a frequency of detection of the reference signal in the at least one other image frame based on one or both of a frame rate associated with the sequence of image frames and scene dynamics.

16. The system of claim 9, wherein the processor block is further configured to:
determine that the reference signal is present in all image frames in a sequence of image frames; and
retrieve data for an image pixel in a first image frame obscured by the reference signal from a corresponding image pixel in a second image frame.

17. An imaging system comprising:
a transmitter configured to transmit a reference signal;
an image sensor configured to:
detect two-dimensional image data associated with a scene; and
detect the reference signal returned from the scene, wherein the reference signal is associated with at least one image pixel of a plurality of image pixels of the two-dimensional image data; and
a processor block configured to:
determine depth data based on the detected reference signal; and
form three-dimensional scene data based on the two-dimensional image data and the depth data.

18. The system of claim 17, wherein the transmitter is configured to transmit the reference signal as one of:
an infrared laser signal; and
a structured light signal.

19. The system of claim 17, wherein the processor block is configured to determine the depth data based on a time-of-flight parameter associated with the reference signal.

20. The system of claim 17, wherein:
the processor block is configured to form the three-dimensional scene data by mapping at least one image pixel in the two-dimensional image data and at least one depth data element in the depth data using the reference signal.

21. The system of claim 17, wherein the image sensor includes at least one of:
an infrared filter for a first sensor pixel having at least one color filter; and
an infrared filter for a second sensor pixel having no color filters.

22. The system of claim 17, wherein the image sensor is further configured to:
detect the two-dimensional image data in at least one image frame of a sequence of image frames; and
detect the reference signal in at least one other image frame of the sequence of image frames.

23. The system of claim 22, wherein the processor block is further configured to adjust a frequency of detection of the reference signal in the at least one other image frame based on one or both of a frame rate associated with the sequence of image frames and scene dynamics.

24. The system of claim 17, wherein the processor block is further configured to:
determine that the reference signal is present in all image frames in a sequence of image frames; and
retrieve data for an image pixel in a first image frame obscured by the reference signal from a corresponding image pixel in a second image frame.
